(19) United States
(12) Patent Application Publication
(10) Pub. No.: US 2013/0332596 A1
(43) Pub. Date: Dec. 12, 2013

(54) NETWORK TRAFFIC TRACKING

(71) Applicants: James O. Jones, Hatfield, PA (US); Joseph M. Wilton, West Chester, PA (US)

(72) Inventors: James O. Jones, Hatfield, PA (US); Joseph M. Wilton, West Chester, PA (US)

(21) Appl. No.: 13/493,044

(22) Filed: Jun. 11, 2012

(51) Int. Cl. G06F 15/173

(52) U.S. Cl. 709/224

(57) ABSTRACT

Network traffic may be logged and analyzed to perform accounting on amount of a chargeable network resource that is consumed fulfilling requests for different clients or for different servers. A network device may report network traffic to a server through NetFlow data records. The network traffic records may be generated by monitoring traffic through either the ingress ports or the egress ports of a network device. Monitoring only ingress or egress ports reduces or eliminates duplication of network traffic counting. Two-directional network traffic may be monitored by transmitting traffic in one direction through a first interface and in a second direction through a second interface.

The instant disclosure relates to computer networking. More specifically, this disclosure relates to logging network traffic in a computer network.

### BACKGROUND

Although once a seemingly unlimited resource, bandwidth in the digital world is becoming more scarce. Today, a single person frequently carries multiple connected devices. Those connected devices are consuming bandwidth at an increasing rate to provide access to large document files and multimedia files. Not only do the number of connected devices strain the networks delivering content, but the connected devices also strain the physical resources providing the content to the networks for delivery to the connected devices. For example, network storage devices, servers, and virtual machines are all serving more clients than before.

Previously, network resources were typically provided in a flat fee arrangement. That is, clients were charged for access to network resources, including the servers and the network infrastructure, based on a monthly or annual charge. The charges were not based on usage of the network resources. In fact, whether a client used the resource continuously or never, the client paid the same fee. The flat fee arrangement produces problems because frequently a few number of users are responsible for the majority of the demand placed on the network resources. Thus, clients using the network resources sparsely are often locked out of the network resources by other clients that are continuously taxing the network resources.

One alternative solution to the flat fee arrangement is to include a cap on services. For example, a client pays a flat fee for access to the network resource, but is only allowed to use a certain amount of the resource before being locked out or charged a surcharge. For example, when the network resource is bandwidth, the client may be locked out or charged a surcharge when usage exceeds a certain number of gigabytes of data. In another example, when the network resource is a virtual machine, the client may be locked out or charged a surcharge when usage exceeds a certain amount of central processing unit (CPU) time. As demand on network resources increases, providers of these resources are seeking other methods for charging clients for their usage of the network resources.

### SUMMARY

According to one embodiment, a method includes receiving in a log file a record of inbound traffic to a network device through an ingress port of a first interface. The method also includes receiving in the log file a record of outbound traffic from the network device through an ingress port of a second interface, different from the first interface. The method further includes measuring inbound and outbound traffic through the network device by analyzing the log file.

According to another embodiment, a computer program product includes a non-transitory computer-readable medium having code to receive in a log file a record of inbound traffic to a network device through an ingress port of a first interface. The medium also includes code to receive in the log file a record of outbound traffic from the network device through an ingress port of a second interface, different from the first interface. The medium further includes code to measure inbound and outbound traffic through the network device by analyzing the log file.

According to a further embodiment, an apparatus a memory for storing packet information and a processor coupled to the memory. The processor is configured to receive in a log file a record of inbound traffic to a network device through an ingress port of a first interface. The processor is further configured to receive in the log file a record of outbound traffic from the network device through an ingress port of a second interface, different from the first interface. The processor is also configured to measure inbound and outbound traffic through the network device by analyzing the log file.

According to another embodiment, a method includes receiving information for a packet of network traffic. The method also includes identifying, for at least one of the packets of logged network traffic, a physical address associated with the packet. The method further includes identifying a computer name corresponding to the physical address. The method also includes assigning the packet to the computer name for charging.

According to yet another embodiment, a computer program product includes a non-transitory computer readable medium having code to receive information for a packet of network traffic. The medium also includes code to identify, for at least one of the packets of logged network traffic, a physical address associated with the one packet. The medium further includes code to identify a computer name corresponding to the physical address. The medium also includes code to assigning the packet to the computer name for charging.

According to a further embodiment, an apparatus includes a memory and a processor coupled to the memory. The processor is configured to read receive information for a packet of network traffic. The processor is also configured to identify, for at least one of the packets of logged network traffic, a physical address associated with the one packet. The processor is further configured to identify a computer name corresponding to the physical address. The processor is also configured to assigning the packet to the computer name for charging.

According to another embodiment, a method includes identifying a physical address of an interface of a network device. The method also includes receiving information for a packet of network traffic. The method further includes determining, for the first packet of the network traffic, when a physical address of the first packet is the interface physical address. The method also includes assigning, when the physical address of the first packet is the interface physical address, a different physical address to the first packet.

According to yet another embodiment, a computer program product includes a non-transitory computer readable medium having code to identify a physical address of an interface of a network device. The medium also includes code to receive information for a first packet of network traffic. The medium further includes code to determine, for the first packet of the network traffic, when a physical address of the first packet is the interface physical address. The medium also includes code to assign, when the physical address of the first packet is the interface physical address, a different physical address to the first packet.

According to a further embodiment, an apparatus includes a memory and a processor coupled to the memory. The processor is configured to identify a physical address of an interface of a network device. The processor is also configured to receive information for a first packet of network traffic. The processor is further configured to determine, for the first packet of the network traffic, when a physical address of the first packet is the interface physical address. The processor is also configured to assign, when the physical address of the first packet is the interface physical address, a different physical address to the first packet.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a network having resource monitoring according to one embodiment of the disclosure.

FIG. 2 is a block diagram illustrating a router with multiple network interface cards for monitoring inbound and outbound traffic according to one embodiment of the disclosure.

FIG. 3 is a block diagram illustrating a router for logging network traffic between multiple networks according to one embodiment of the disclosure.

FIG. 4 is a flow chart illustrating a method of capturing network traffic according to one embodiment of the disclosure.

FIG. 5 is a flow chart illustrating a method of assigning computers to logged network traffic according to one embodiment of the disclosure.

FIG. 6 is a flow chart illustrating a method of identifying and correcting erroneous logged information according to one embodiment of the disclosure.

FIG. 7 is a table illustrating pairing of physical addresses and logical addresses according to one embodiment of the disclosure.

FIG. 8 is block diagram illustrating a computer network according to one embodiment of the disclosure.

FIG. 9 is a block diagram illustrating a computer system according to one embodiment of the disclosure.

FIG. 10A is a block diagram illustrating a server hosting an emulated software environment for virtualization according to one embodiment of the disclosure.

FIG. 10B is a block diagram illustrating a server hosing an emulated hardware environment according to one embodiment of the disclosure.

### DETAILED DESCRIPTION

Clients may be charged for access to network resources based on their utilization of the network resources. For example, when a client consumes a network resources a log is created storing the amount of the network resource consumed. Traffic through a network device may be logged and clients charged for the network resources by analyzing the log file and generating charges.

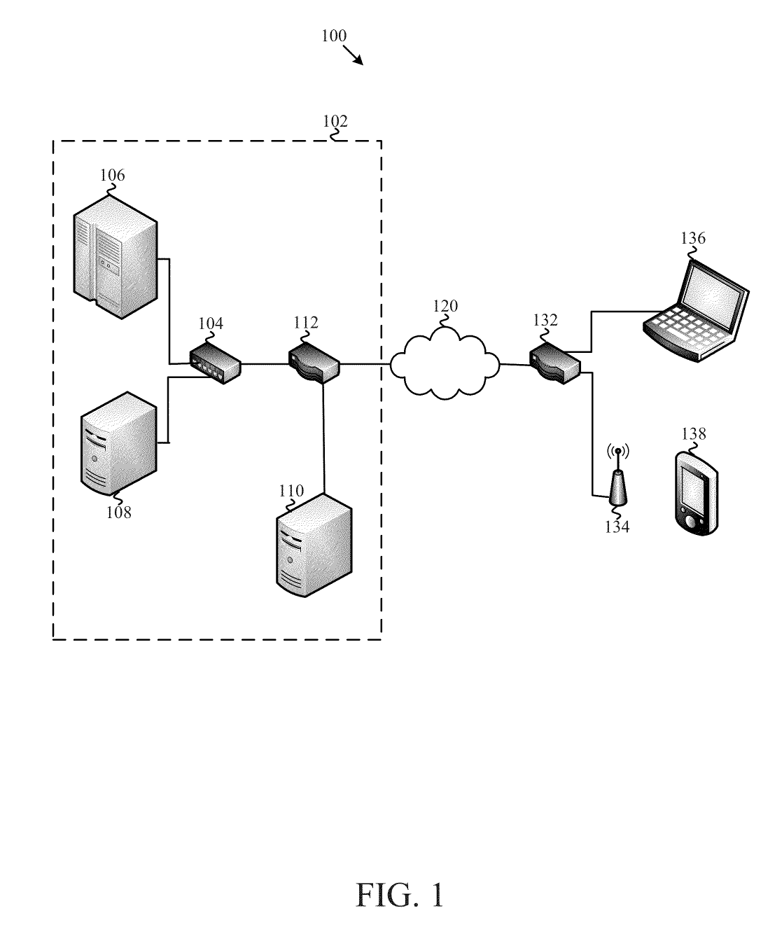

Network logging may be performed at a network device positioned at an entry to the network resources being monitored. FIG. 1 is a block diagram illustrating a network having resource monitoring according to one embodiment of the disclosure. Chargeable network resources 102 may include a server 108, a mainframe server 106, and other servers or devices. Any of the servers 106-108 may be virtualized as virtual machines executing on a higher capacity server (not shown). Alternatively, each of the servers 106-108 may provide multiple virtual machines for executing applications on behalf of clients. The servers 106-108 may be connected to a communications device 104, such as a hub, a switch, or a router. The communications device 104 may be coupled to a border router 112 for handling traffic between the chargeable network resources 102 and a public network 120, such as the Internet.

The public network 120 couples client devices, such as a laptop computer 136 and a smart phone 138 to the chargeable network resources 102. The client devices 136 and 138 may couple to the public network 132 through wired connections to a router 132 or through a wireless connection to a wireless access point 134. When the client devices 136 and 138 access the network resources 102, network traffic passes through the border router 112 to the servers 106 and/or 108. Thus, the border router 112 may log network traffic between the client devices 138 and 138 with the servers 106 and 108.

The border router 112 may communicate to a server 110 log files for analysis, filtering, and/or charging. According to one embodiment, information is passed from the border gateway 112 to the server 110 in a NetFlow record format. The server 110 may analyze the logged data reported from the border router 112. During analysis, the server 110 may filter the records to reduce processing time of the records. For example, filtering may remove logged traffic having a public source address and a public destination address. In another example, filtering may remove logged traffic having a private source address and a private destination address. After filtering the logged network traffic and analyzing the logged network traffic, the server 110 may charge subscribers of the network resources 102 based on usage from the client devices 136 and 138.

According to one embodiment, the server 110 is a management server executing a system service. The system service listens for Netflow packets received from the border router 112. The Netflow packets may be transferred in a universal datagram packet (UDP). Although the server 110 is illustrated as only receiving packets from the border router 112, the server 110 may receive packets from any of the network devices, including the servers 106 and 108 and the communications device 104. That is, NetFlow packets may be generated from any device within the chargeable network resources 102, which may include devices at other sites (not shown).

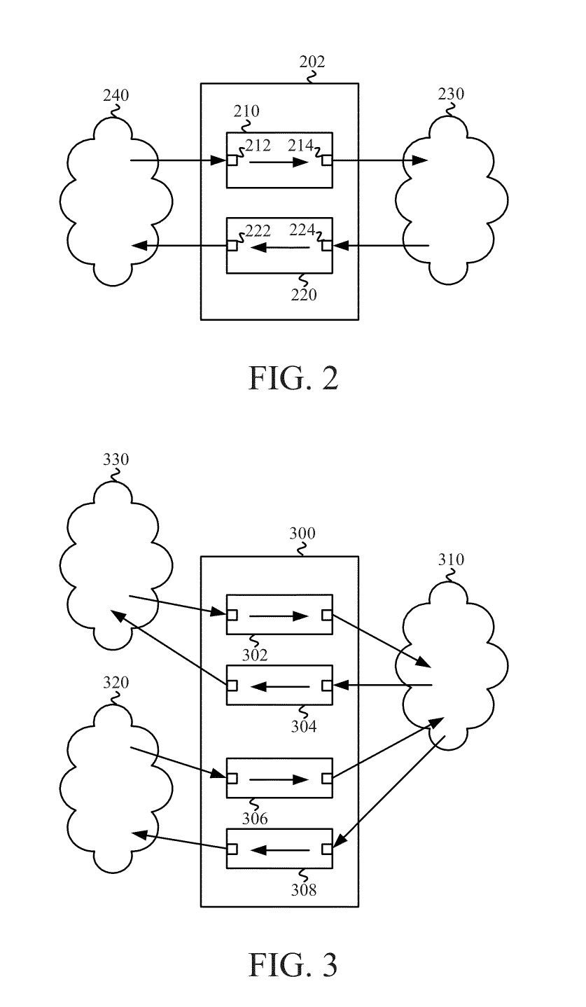

Traffic logging at the border router 112 may be implemented with a combination of network interface cards (NICs). FIG. 2 is a block diagram illustrating a router with multiple network interface cards for monitoring inbound and outbound traffic according to one embodiment of the disclosure. A router 202 may include network interface cards 210 and 220 for relaying data from a network 230 to a network 240. Each of the interfaces 210 and 220 may be assigned to handle one direction of network traffic. That is, traffic from the network 240 to the network 230 is handled by the interface 210, and traffic from the network 240 to the network 230 is handled by the interface 220.

The interface 210 may include an ingress port 212 and an egress port 214. The ingress port 212 may be coupled to the network 240, and the egress port 214 may be coupled to the network 230. Likewise, the interface 220 has an ingress port 224 coupled to the network 230 and an egress port 222 coupled to the network 240. The router 202 may capture network traffic on only the ingress ports 212 and 224 or only the egress ports 222 and 214 to reduce or eliminate double counting of network traffic. If network traffic is captured at ingress ports 224 and 212 and egress ports 214 and 222, additional filtering and/or analysis of the network traffic may be performed to identify double counted network traffic. For example, a packet inbound from the network 230 to the ingress port 224 may be matched with a packet outbound from the egress port 222 to the network 240.

Routers may include multiple network interface cards for handling network traffic depending on configuration of the network. For example, when multiple communication links are implemented to couple the border router to the public network, each communication link may be coupled to two network interface cards in the border router. In particular, one network interface card may be assigned for inbound communications and one network interface card may be assigned for outbound network communications through each communication link. In another example, when chargeable network resources are partitioned into different groups the border router may include network interface cards for each partition of chargeable network resources. In particular, one network interface card assigned for inbound communications and one network interface card assigned for outbound network communications to each partition of chargeable network resources.

FIG. 3 is a block diagram illustrating a router for logging network traffic between multiple networks according to one embodiment of the disclosure. A router 300 may include network interface cards 302, 304, 306, and 308. The network interface cards 302 and 304 may be coupled to a communications link to a public network 310. The network interface cards 306 and 308 may be coupled through a different communications link to the public network 310. The interfaces 302 and 304 may couple the public network 310 to a first partition 330 of chargeable network resources. The interfaces 306 and 308 may couple the public network 310 to a second partition 320 of chargeable network resources. Thus, the router 300 may log network traffic separately for client access to the first partition 330 and second partition 320 of chargeable network resources. When the log is analyzed, different fee arrangements may be assigned to network traffic to the first partition 330 and the second partition 320. The partitioning of the chargeable network resources into the first partition 330 and the second partition 320 may also improve security by preventing unauthorized access to network resources within the first partition 330 and the second partition 320.

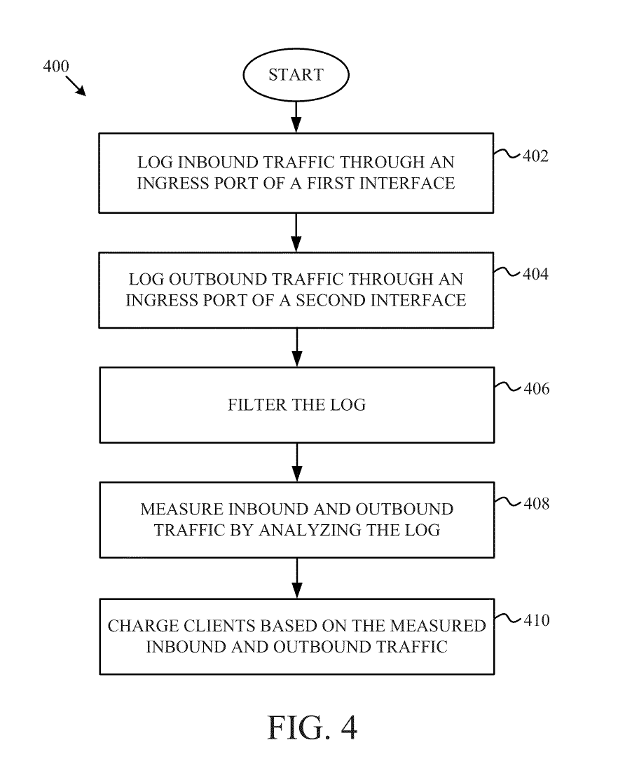

FIG. 4 is a flow chart illustrating a method of capturing network traffic according to one embodiment of the disclosure. A method 400 begins at block 402 with logging inbound traffic through an ingress port of a first network interface card of a network device, such as a router, switch, gateway, and/or hub. At block 404, outbound traffic through an ingress port of a second network interface card of the network device is logged. At block 406, the log is filtered to remove undesired entries, such as entries that do not correspond to chargeable traffic. At block 408, the inbound and outbound traffic is measured by analyzing the filtered log. At block 410, clients are charged fees based on the measured inbound and outbound traffic. According to one embodiment, filtering, measuring, and charging as described in blocks 406, 408, and 410 may be performed by a device, such as a server, other than the network device. In this embodiment, the network device exports the log data to the server. The exported data may be transmitted in real-time or in accumulated groups at timed intervals. According to one embodiment, the exported data is formatted as NetFlow records.

The logged network traffic may include information contained in the packets transmitted through the interfaces of the network device. The information may include destination logical address, source logical address, destination physical address, destination physical address. When the packets are transmitted according to the internet protocol (IP), the information may include a source IP address, a destination IP address, a source MAC address, and a destination MAC address. The information in the packet may be used for networking logging network traffic as described above. The information in the packet may also be used for assigning traffic to a particular computer for purposes of charging the client on the particular computer.

Logical addresses, such as IP addresses, may be analyzed for assigning network traffic to a particular client. Because logical addresses change, locating a computer assigned to the IP address may be performed by sending look-up requests to a Dynamic Host Control Protocol (DHCP) server and/or an Active Directory server on the network. Instead, physical addresses, such as MAC addresses, may be used to assign network traffic to a particular computer. Physical addresses rarely change and, thus, are good candidates for identifying the particular computer accessing chargeable resources.

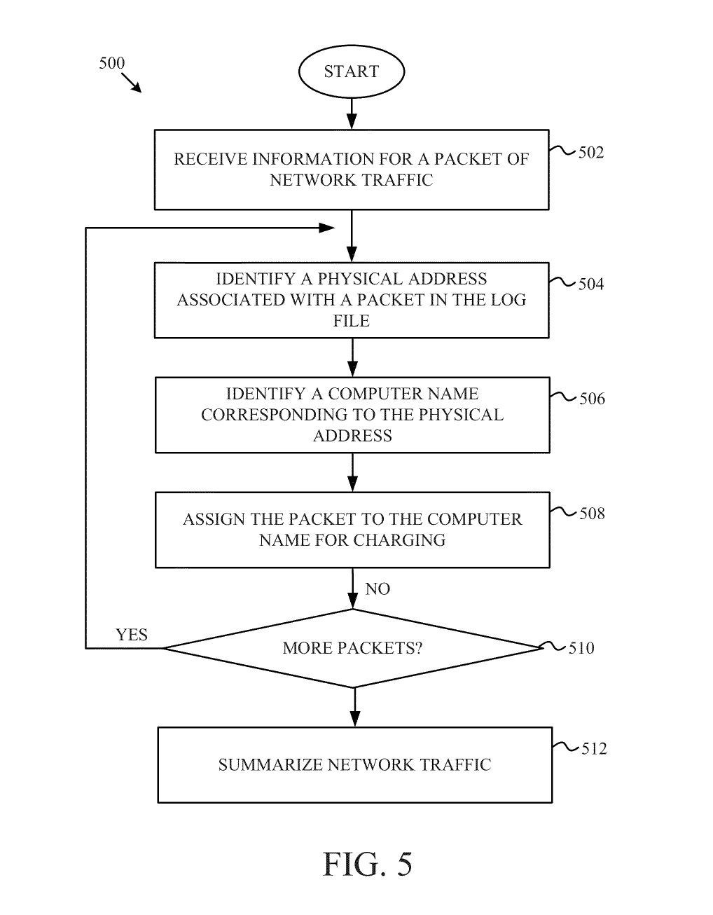

FIG. 5 is a flow chart illustrating a method of assigning computers to logged network traffic according to one embodiment of the disclosure. A method 500 begins at block 502 with receiving information for a packet, such as reading a log file of packets of network traffic. The log file may be a stored file containing logged network traffic from prior communications with a chargeable network resource. For example, the log file may be stored on the server 110 as information is delivered by the border router 112 but processed at intervals, such as bi-weekly or monthly. The log file read at block 502 may also be a file currently open on the server 110 and storing data from the border router 112. Alternatively, the log file may serve as only a buffer for storing received data from the border router 112 until processed by the method 500 in near real-time. According to one embodiment, the log file is processed in units of data such as packets, however the log file may also be processed in other units, such as cells, bytes, or seconds.

For each packet, or other unit of data, the method 500 repeats blocks 504, 506, and 508. At block 504, a physical address of the packet is identified. The physical address may be used for analyzing the packet, because logical addresses may be duplicated within a network. For example, two private networks with overlapping logical address ranges may exist within a larger network connected to the network device. At block 506, a computer name corresponding to the physical address is identified, and at block 508, the packet is assigned to the identified computer name for charging. The identification of the computer name at block 506 may be performed by accessing a look-up table mapping physical addresses and computer names. The computer name may represent a server or a virtual machine executing on a server in the chargeable network resources. Alternatively, the computer name may represent a client device. The look-up table may be stored on the border router 112, the server 110, and/or another server or network device. At block 510, it is determined whether any data remains in the log file for processing. If so, the method 500 returns to block 504 to process the additional data. After processing of the packets, the network traffic may be summarized at block 512, such as in a billing statement. The summarized network traffic may be accessed by a client through a web portal and/or a proprietary application. Alternatively, the summary may be generated as a bill and sent to the client through mail or electronic mail.

While processing the log file, information regarding networks connected to the network device may be assembled and stored. For example, IP packets include a pair of a MAC address and an IP address for both a source and a destination of the IP packet. The pairing of a logical address and a physical address represented in each packet of network traffic may be used for detecting errors in the log file or the data recorded in the log file. For example, information for some packets recorded in the log file may contain a physical address of the network device generating the log of network traffic. These packets should not be assigned to the network device. Rather, these packets should be assigned to the client accessing the chargeable network resources. When information in the log file for a packet having an incorrect physical address is detected, the log file may be altered to contain a different physical address corresponding to a client device.

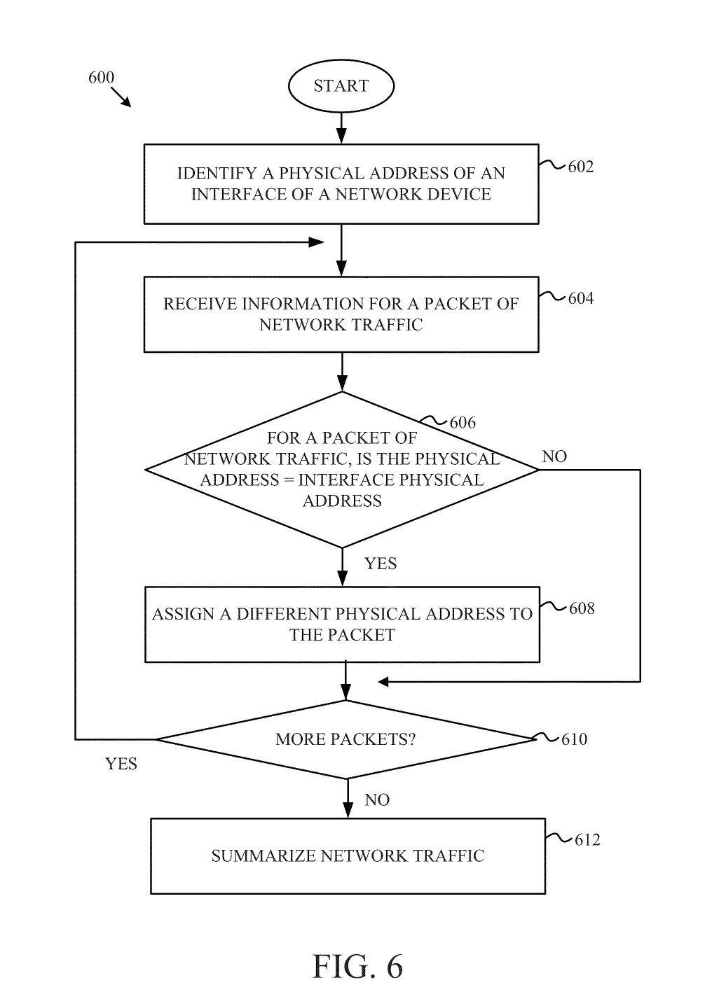

FIG. 6 is a flow chart illustrating a method of identifying and correcting erroneous logged information according to one embodiment of the disclosure. A method 600 begins with identifying a physical address of an interface of a network device. The physical addresses may be recorded in a configuration file or stored in memory. For example, the physical address of ingress ports 224 and 212 and egress ports 214 and 222 of the network device 202 of FIG. 2 may be identified. When the physical address of these ports are read from a log file for a packet of network traffic, a procedure, such as that described below, may be executed to correctly assign the network traffic to a client device.

At block 604, information for a packet of network traffic is received. According to one embodiment, a log file is processed for each packet recorded in the log file. Other processing schemes may be implemented, such as when the units of data recorded in the log file are not packets but cells or bytes. At block 606, it is determined whether the physical address of the packet being processed is equal to the physical address of one of the interfaces of the network device recording the network traffic. If so, a different physical address is assigned to the packet at block 608. The different physical address may be assigned by altering the log file and/or changing the address value stored in temporary memory. If the method 600 is executing on the network device, the different physical address may be assigned before transmitting the log information in NetFlow data records. The method 600 then continues to block 610 to process additional packets. If the physical address of the packet is not the same as the interface physical address, the method 600 continues to block 610 to process additional packets. After all packets are processed, additional analysis may be performed on the log file, such as summarizing the network traffic at block 612.

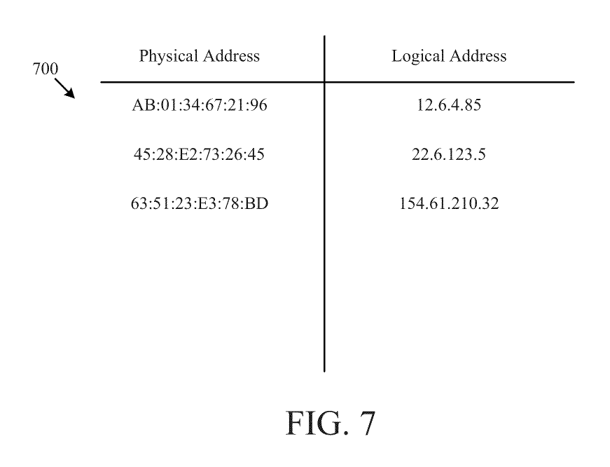

Although FIGS. 5 and 6 are shown as separate flow charts, the methods 500 and 600 may be performed in parallel. For example, as each packet of data of a log file is processed, the packet may be examined for errors, such as through the method 600, and then assigned to a computer name, such as through the method 500. Additional processing may also be performed as each packet from the log file is processed. According to one embodiment, the pair of physical address and logical address from a packet are stored in a look-up table, such as a look-up table illustrated in FIG. 7.

FIG. 7 is a table illustrating pairing of physical addresses and logical addresses according to one embodiment of the disclosure. A table 700 includes physical addresses 702 and logical addresses 704. The pairs of physical addresses and logical addresses are created in the table 700 by processing packets of logged network traffic. The table 700 may be used to detect errors in the log file or in the data recorded in the log file. For example, if a packet is processed from the log file and the physical address of the packet matches a physical address in the table 700 but the logical address of the packet does not match the logical address in the table 700 corresponding to the physical address, then corrective measures may be taken. One corrective measure may be to reassign the physical address to the new logical address, because the client device has changed location or received a new logical address.

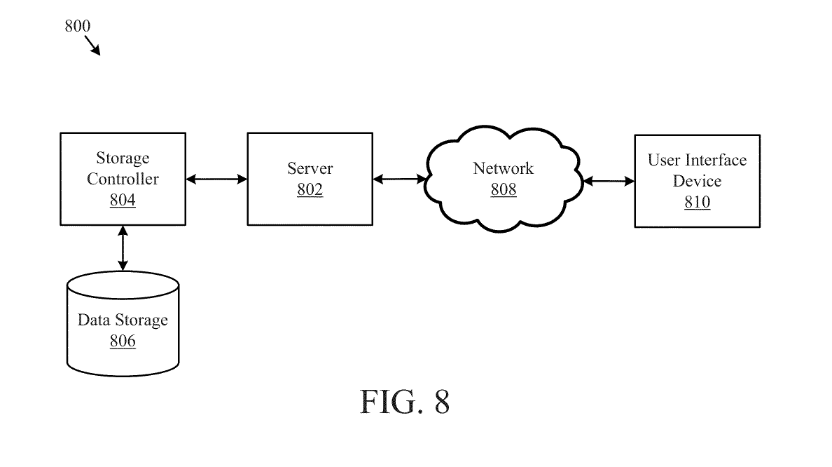

FIG. 8 illustrates one embodiment of a system 800 for an information system, such as a system for analyzing and reporting network traffic. The system 800 may include a server 802, a data storage device 806, a network 808, and a user interface device 810. The server 802 may be a dedicated server or one server in a cloud computing system. In a further embodiment, the system 800 may include a storage controller 804, or storage server configured to manage data communications between the data storage device 806 and the server 802 or other components in communication with the network 808. In an alternative embodiment, the storage controller 804 may be coupled to the network 808.

In one embodiment, the user interface device 810 is referred to broadly and is intended to encompass a suitable processor-based device such as a desktop computer, a laptop computer, a personal digital assistant (PDA) or tablet computer, a smartphone or other a mobile communication device having access to the network 808. When the device 810 is a mobile device, sensors (not shown), such as a camera or accelerometer, may be embedded in the device 810. When the device 810 is a desktop computer the sensors may be embedded in an attachment (not shown) to the device 810. In a further embodiment, the user interface device 810 may access the Internet or other wide area or local area network to access a web application or web service hosted by the server 802 and provide a user interface for enabling a user to enter or receive information.

The network 808 may facilitate communications of data, such as authentication information, between the server 802 and the user interface device 810. The network 808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 810 accesses the server 802 through an intermediate sever (not shown). For example, in a cloud application the user interface device 810 may access an application server. The application server fulfills requests from the user interface device 810 by accessing a database management system (DBMS). In this embodiment, the user interface device 810 may be a computer or phone executing a Java application making requests to a JBOSS server executing on a Linux server, which fulfills the requests by accessing a relational database management system (RDMS) on a mainframe server.

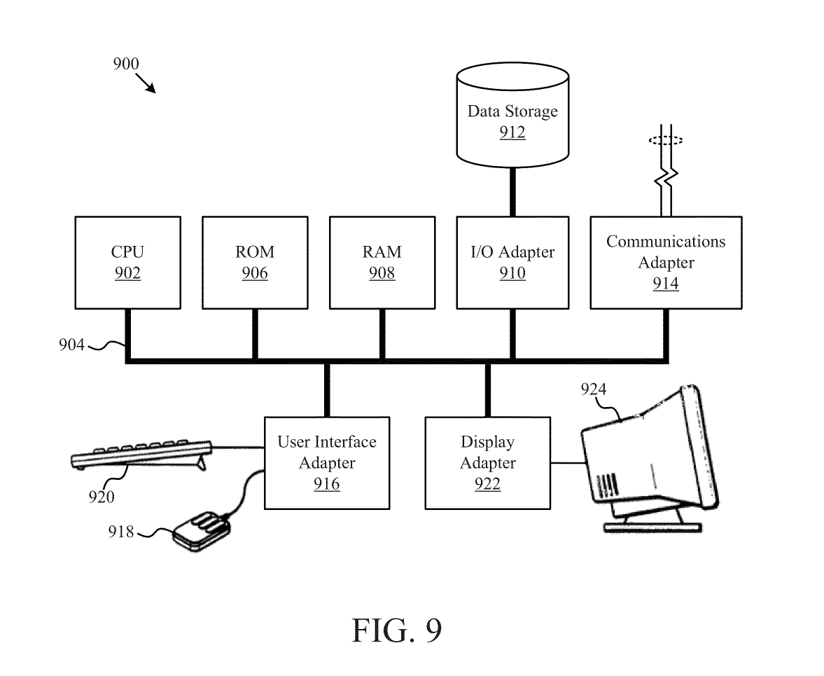

FIG. 9 illustrates a computer system 900 adapted according to certain embodiments of the server 802 and/or the user interface device 810. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the operations as described herein. The CPU 902 may execute the various logical instructions according to the present embodiments.

The computer system 900 also may include random access memory (RAM) 908, which may be synchronous RAM (SRAM), dynamic RAM (DRAM), synchronous dynamic RAM (SDRAM), or the like. The computer system 900 may utilize RAM 908 to store the various data structures used by a software application. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a solid state storage device, a flash drive, a compact disc (CD) drive, a floppy disk drive, and a tape drive, to the computer system 900. According to one embodiment, the data storage 912 may be a separate server coupled to the computer system 900 through a network connection to the I/O adapter 910. The communications adapter 914 may be adapted to couple the computer system 900 to the network 808, which may be one or more of a LAN, WAN, and/or the Internet. The communications adapter 914 may also be adapted to couple the computer system 900 to other networks such as a global positioning system (GPS) or a Bluetooth network. The user interface adapter 916 couples user input devices, such as a keyboard 920, a pointing device 918, and/or a touch screen (not shown) to the computer system 900. The keyboard 920 may be an on-screen keyboard displayed on a touch panel. Additional devices (not shown) such as a camera, microphone, video camera, accelerometer, compass, and or gyroscope may be coupled to the user interface adapter 916. The display adapter 922 may be driven by the CPU 902 to control the display on the display device 924. Any of the devices 902-922 may be physical, logical, or conceptual.

The applications of the present disclosure are not limited to the architecture of computer system 900. Rather the computer system 900 is provided as an example of one type of computing device that may be adapted to perform the functions of a server 802 and/or the user interface device 810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 900 may be virtualized for access by multiple users and/or applications.

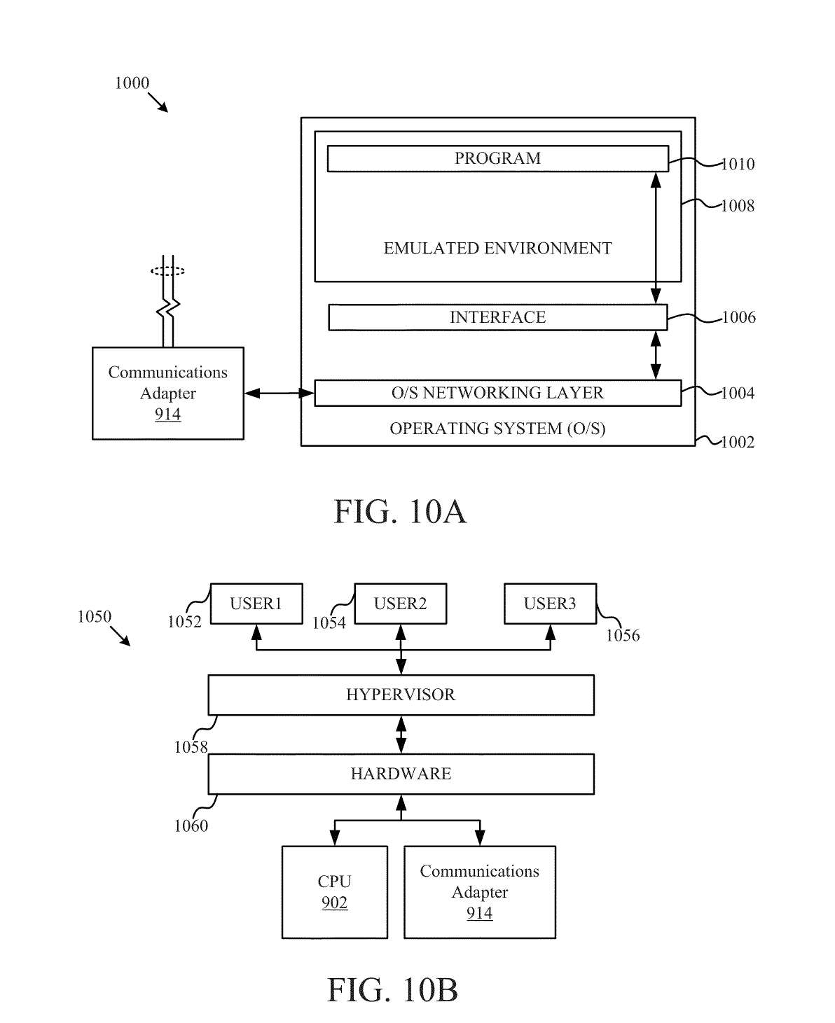

FIG. 10A is a block diagram illustrating a server hosting an emulated software environment for virtualization according to one embodiment of the disclosure. An operating system 1002 executing on a server includes drivers for accessing hardware components, such as a networking layer 1004 for accessing the communications adapter 914. The operating system 1002 may be, for example, Linux. An emulated environment 1008 in the operating system 1002 executes a program 1010, such as CPCommOS. The program 1010 accesses the networking layer 1004 of the operating system 1002 through a non-emulated interface 1006, such as XNIOP. The non-emulated interface 1006 translates requests from the program 1010 executing in the emulated environment 1008 for the networking layer 1004 of the operating system 1002.

In another example, hardware in a computer system may be virtualized through a hypervisor. FIG. 10B is a block diagram illustrating a server hosing an emulated hardware environment according to one embodiment of the disclosure. Users 1052, 1054, 1056 may access the hardware 1060 through a hypervisor 1058. The hypervisor 1058 may be integrated with the hardware 1060 to provide virtualization of the hardware 1060 without an operating system, such as in the configuration illustrated in FIG. 10A. The hypervisor 1058 may provide access to the hardware 1060, including the CPU 902 and the communications adaptor 914.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving in a log file a record of inbound traffic to a network device through an ingress port of a first interface;
receiving in the log file a record of outbound traffic from the network device through an ingress port of a second interface, different from the first interface; and
measuring inbound and outbound traffic through the network device by analyzing the log file.

2. The method of claim 1, further comprising filtering the log file before measuring the inbound and outbound traffic.

3. The method of claim 2, in which the step of filtering comprises removing logged traffic having a public source address and a public destination address.

4. The method of claim 2, in which the step of filtering comprises removing logged traffic having a private source address and a private destination address.

5. The method of claim 1, in which the log file is received in a NetFlow format.

6. The method of claim 5, further comprising charging a customer based on the measured inbound and outbound traffic.

7. The method of claim 1, further comprising logging traffic from a third network interface, different from the first network interface and the second network interface, to the log.

8. A computer program product, comprising:
a non-transitory computer-readable medium comprising:
code to receive in a log file a record of inbound traffic to a network device through an ingress port of a first interface;
code to receive in the log file a record of outbound traffic from the network device through an ingress port of a second interface, different from the first interface; and
code to measure inbound and outbound traffic through the network device by analyzing the log file.

9. The computer program product of claim 8, in which the medium further comprises code to filter the log file before measuring the inbound and outbound traffic.

10. The computer program product of claim 9, in which the medium further comprises code to remove logged traffic having a public source address and a public destination address.

11. The computer program product of claim 9, in which the medium further comprises code to remove logged traffic having a private source address and a private destination address.

12. The computer program product of claim 8, in which the medium further comprises code to interpret the log file according to a NetFlow format.

13. The computer program product of claim 12, in which the medium further comprises code to charge a customer based on the measured inbound and outbound traffic.

14. An apparatus, comprising:
a memory for storing packet information; and
a processor coupled to the memory, in which the processor is configured:
to receive in a log file a record of inbound traffic to a network device through an ingress port of a first interface;
to receive in the log file a record of outbound traffic from the network device through an ingress port of a second interface, different from the first interface; and
to measure inbound and outbound traffic through the network device by analyzing the log file.

15. The apparatus of claim 14, in which the processor is further configured to filter the log file before measuring the inbound and outbound traffic.

16. The apparatus of claim 14, in which the processor is further configured to remove logged traffic having a public source address and a public destination address.

17. The apparatus of claim 14, in which the processor is further configured to analyze the log file according to a NetFlow format.

18. The apparatus of claim 14, in which the processor is further configured to generate a charge for a customer based on the measured inbound and outbound traffic.

19. The apparatus of claim 14, in which the network device is at least one of a router, a switch, and a gateway.
